(19) United States
(12) Patent Application Publication
(10) Pub. No.: US 2012/0067940 A1
(43) Pub. Date: Mar. 22, 2012

(54) ELECTRICAL CONTACT STRUCTURES SUITABLE FOR USE ON WAFER TRANSLATORS AND METHODS OF MAKING SAME

(76) Inventor: Dodgie Reigh M. Calpito, Itasca, IL (US)

(21) Appl. No.: 13/106,743

(22) Filed: May 12, 2011

Related U.S. Application Data
(60) Provisional application No. 61/345,055, filed on May 14, 2010.

(51) Int. Cl. B23K 31/02

(52) U.S. Cl. 228/159

(57) ABSTRACT

Electrical contact structures suitable for use on the wafer-side of wafer translators are produced using the programmable features of a wire-bonding machine and further using subsequent steps including but not limited to, masking, etching, grinding, and annealing. In one aspect, multiple electronic flame-off (EFO) operations are performed to produce both a free-air ball at one end of a wire for ball bonding, and to produce a region of modified grain structure in the wire at a predetermined distance from the free-air ball. The grain structure modification obtained by EFO operations affects the tail termination operation of the wire bonding machine thereby controlling, at least in part, the contact structure height and tip shape.

### CROSS REFERENCE TO RELATED APPLICATION

This application claims priority to U.S. Provisional Application No. 61/345,055, filed on May 14, 2010, and entitled “ELECTRICAL CONTACT STRUCTURES SUITABLE FOR USE ON WAFER TRANSLATORS AND METHODS OF MAKING SAME,” which is incorporated herein in its entirety by reference.

### TECHNICAL FIELD

The present invention relates generally to electrical contact structures suitable for use on the wafer-side of wafer translators, and methods of making the same. More particularly, formation of such electrical contacts, which are suitable for making electrical connection between the pads of unsingulated integrated circuits on a semiconductor wafer and the electrical pathways of the wafer translator, includes the use of a wire-bonding machine.

### BACKGROUND

Advances in semiconductor manufacturing technology have resulted in, among other things, reducing the cost of sophisticated electronics to the extent that integrated circuits have become ubiquitous in the modern environment.

As is well-known, integrated circuits are typically manufactured in batches, and these batches usually contain a plurality of semiconductor wafers within and upon which integrated circuits are formed through a variety of semiconductor manufacturing steps, including, for example, masking, patterning, depositing, ion implanting, annealing, etching, planarizing and so on. Typical integrated circuits include circuit elements such as, for example, transistors and diodes. These circuit elements are formed in and near the surface of the wafer.

It is common to manufacture integrated circuits on roughly circular semiconductor substrates, or wafers. Further, it is common to form such integrated circuits so that conductive regions disposed on, or close to, the uppermost layers of the integrated circuits are available to act as terminals for connection to various electrical elements disposed in, or on, the lower layers of those integrated circuits. These terminals are often referred to as pads. Completed wafers are tested to determine which die, or integrated circuits, on the wafer are capable of operating according to predetermined specifications. In this way, integrated circuits that cannot perform as desired are not packaged, or otherwise incorporated into finished products. In testing, these pads are commonly contacted with a probe card.

Unfortunately, there are some problems associated with the fabrication and use of probe cards. The maintenance of probe tip accuracy, good signal integrity, and overall dimensional accuracy severely strains probe card fabrication and repair methods because of the multiple component and assembly error budget entries.

An alternative to probe cards in the testing of unsingulated integrated circuits on semiconductor wafers is the wafer translator. One aspect of wafer translator design and fabrication relates to the contact structures on the wafer-side of wafer translators. These contact structures serve to provide an electrical connection between the pads of integrated circuits and the electrically conductive pathways of the wafer translator.

What is needed are contact structures suitable for use on the wafer-side of wafer translators and methods for making the same.

### SUMMARY

Briefly, contact structures suitable for use on the wafer-side of wafer translators are produced using the programmable features of a wire-bonding machine and further using subsequent steps including but not limited to, masking, etching, grinding, and annealing.

In one aspect, multiple electronic flame-off (EFO) operations are performed to produce both a free-air ball at one end of a wire for ball bonding, and to produce a region of modified grain structure in the wire at a predetermined distance from the free-air ball. The grain structure modification obtained by EFO operations affects the tail termination operation of the wire bonding machine thereby controlling, at least in part, the contact structure height and tip shape.

### BRIEF DESCRIPTION OF THE DRAWINGS

FIG. 1 is an illustration of a conventional wire, capillary, and electronic flame-off (EFO) apparatus as used in a wire-bonding machine.

FIG. 2 is an illustration a conventional free-air ball formed, at the end of a wire extending from the capillary, by interaction of the wire and the EFO apparatus.

FIGS. 3A-3C illustrate, in accordance with the present invention, various steps in a process of making a contact structure suitable for use on wafer translators.

FIG. 4 is an illustration of the formation of a contact structure through the action of a wire bonding machine subsequent to forming an annealed zone in the wire and ball bonding the free-air ball to a contact pad.

FIG. 5 is an illustration of the contact structure formed in accordance with the process of the present invention.

FIG. 6 is a cross-sectional view of a folded contact structure in accordance with the present invention in which a ball-bond and a wedge-bond are used.

FIG. 7 is a cross-sectional view of a loop of wire having a ball-bond at one end, and a wedge-bond at the other end.

FIG. 8 shows the structure of FIG. 7, after a coating of protective material is disposed over the wire loop.

FIG. 9 shows the structure of FIG. 8, after grinding wheel has begun to remove an upper portion of the protective coating and a horizontal portion of the wire.

FIG. 10 shows the structure of FIG. 8, after an upper portion of the protective coating has been removed.

FIG. 11 shows the structure of FIG. 10, after the horizontal portion of the wire has been removed.

FIG. 12 shows the structure of FIG. 11, after the remainder of the protective coating is removed.

FIG. 13 shows the structure of FIG. 11, after a masking material is patterned onto the exposed surface of the remainder of the protective coating.

FIG. 14 shows the structure of FIG. 13, after the unmasked portion of the protective coating, and the wedge-bonded portion of the wire have been removed; and after the patterned masking material has been removed.

FIG. 15 shows the structure of FIG. 14, after the protective coating surrounding the ball-bonded portion of the wire has been removed.

FIG. 16 is a cross sectional view of an illustrative wafer translator having contact structures disposed of the wafer-side thereof.

### DETAILED DESCRIPTION

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

### Terminology

The term “pad”, as used herein, generally refers to a conductive region where physical and electrical connection between one component and another is made. In the context of integrated circuits, pad typically refers to a metallized region of the surface of the integrated circuit, which is commonly used to form a physical connection terminal for communicating signals to and/or from the integrated circuit. Such integrated circuit pads may be formed of a metal, a metal alloy, or a stack structure including several layers of metals and/or metal alloys that are present, typically, at the uppermost layer of conductive material of an integrated circuit.

The expression “wafer translator” refers to an apparatus facilitating the connection of I/O pads (sometimes referred to as terminals, pads, contact pads, bonding pads, chip pads, or test pads) of unsingulated integrated circuits, to other electrical components. It will be appreciated that “I/O pads” is a general term, and that the present invention is not limited with regard to whether a particular pad of an integrated circuit is part of an input, output, or input/output circuit. A wafer translator may be disposed between a wafer and other electrical components. The wafer translator includes a substrate having two major surfaces, each surface having terminals disposed thereon, and electrical pathways disposed through the substrate to provide for electrical continuity between at least one terminal on a first surface and at least one terminal on a second surface. The major surface designed to be disposed on a wafer is referred to herein as the wafer-side of the wafer translator. The wafer-side of the wafer translator has a pattern of terminals that matches the layout of at least a portion of the I/O pads of the integrated circuits on the wafer. The wafer translator, when disposed between a wafer and other electrical components, makes electrical contact with one or more I/O pads of a plurality of integrated circuits on the wafer, providing an electrical pathway therethrough to the other electrical components. The wafer translator is a structure that is used to achieve electrical connection between one or more electrical terminals that have been fabricated at a first scale, or dimension, and a corresponding set of electrical terminals that have been fabricated at a second scale, or dimension. The wafer translator provides an electrical bridge between the smallest features in one technology (e.g., pins of a probe card) and the largest features in another technology (e.g., bonding pads of an integrated circuit). For convenience, wafer translator is referred to simply as translator where there is no ambiguity as to its intended meaning.

The terms chip, integrated circuit, semiconductor device, and microelectronic device are sometimes used interchangeably in this field. Further, the term die (pl. dice) is understood in this context to refer to The present invention relates to the manufacture and test of chips, integrated circuits, semiconductor devices and microelectronic devices as these terms are commonly understood in the field.

In one aspect of the present invention, in a wire-bonding machine including a capillary, a wire and an electronic flame-off apparatus, a free-air ball is formed at a distal end of the wire by a first electronic flame-off operation, the relative position of the wire and electronic flame-off apparatus are changed, a second electronic flame-off operation is performed so as to create an annealed zone in the wire between the free-air ball and the capillary, the wire is ball bonded to a conductive pad on the wafer-side of a wafer translator, the relative position of capillary and the wafer translator is changed such that the annealed zone of wire is stretched and separates into at least two pieces, one being a contact structure ball bonded to the wafer translator and having a pointed tip.

In another aspect of the present invention, one contact structure is formed from a single loop of wire that is bonded in two places to the wafer-side of a wafer translator. In a wire-bonding machine including a capillary, a wire and an electronic flame-off apparatus, a first end of the wire is ball-bonded to a conductive region, a second end of the wire is wedge-bonded to the conductive region, wherein the distance between the ball-bond and the wedge-bond is such that a portion of the wire disposed between the ball-bond and the wedge-bond is folded together. This provides a contact structure suitable for use on the wafer side of the wafer translator. The height of the contact structure is programmable by means of supplying control information to the wire bonding machine.

In another aspect of the present invention, two contact structures are formed from a single loop of wire that is bonded in two places to the wafer-side of a wafer translator. In a wire-bonding machine including a capillary, a wire and an electronic flame-off apparatus, a first end of the wire is ball-bonded to a conductive region, a second end of the wire is then wedge-bonded to the same or a different conductive region, wherein the distance between the ball-bond and the wedge-bond is such that the portion of the wire disposed between the ball-bond and the wedge-bond is an open loop, i.e., not touching. The wire loop has a portion extending generally upwardly from the ball-bond, a portion extending generally upwardly from the wedge-bond, and a portion disposed generally horizontally between the two upwardly extending portions. A protective material coating is disposed over the wire, and an upper portion of the protective material and the horizontal portion of the wire is removed. By removing the horizontal portion of the wire, two substantially upwardly extending contact structures are formed. The remainder of the protective material coating is then removed, typically by wet chemical treatment. In at least one embodiment, the upper portion of the coating and the horizontal portion of the wire are removed mechanically by, for example, a grinding wheel. In at least one embodiment, the upper portion of the coating and the horizontal portion of the wire are removed by chemical etching. It is noted that, depending on the material properties of the coating material and the wire, the upper portion of the coating material and the horizontal portion of the wire may be removed concurrently, or the coating material may be removed first by chemical etching and then the horizontal portion of the wire may be removed either chemically or mechanically.

In another aspect of the present invention, one contact structure is formed from a single loop of wire that is bonded in two places to the wafer-side of a wafer translator. Two substantially vertically-oriented contact structures are formed from a single loop of wire that has a ball-bond at one end and a wedge-bond at the other end. One of the two contact structures is then removed either mechanically or chemically.

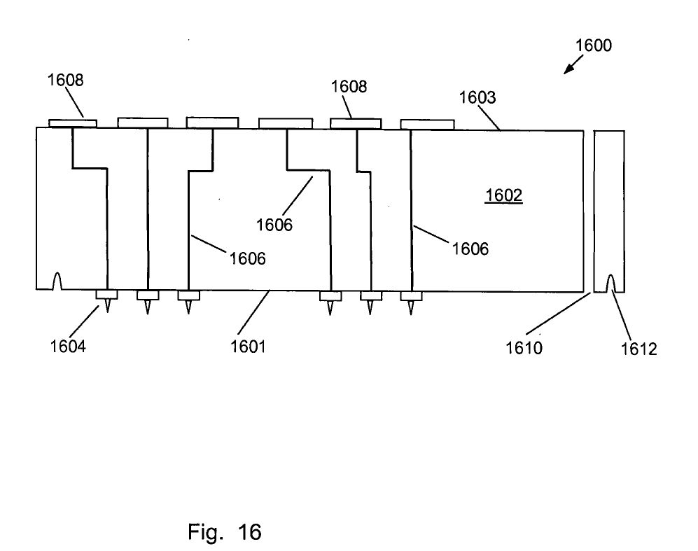

FIG. 16 is a cross-sectional view of an illustrative wafer translator 1600. Wafer translator 1600 includes a substrate 1602 with a first major surface 1601 and a second major surface 1603. First major surface 1601 may be referred to as the wafer-side of wafer translator 1602. Second major surface 1603 may be referred to as the inquiry-side of wafer translator 1602. Alternatively, second major surface 1603 may be referred to as the tester-side. Contact structures 1604 are disposed on wafer-side 1603. Contact structures 1604 are arranged in a pattern such that they match the layout of pads disposed on the integrated circuits and/or process characterization test sites of a predetermined wafer. Contact terminals 1608 are disposed on tester-side 1603 of wafer translator 1602. Contact terminals 1608 are typically larger than contact structures 1604, and are typically laid out in a regular pattern intended to couple with a tester or tester interface. Contact terminals 1608 and contact structures 1604 are electrically coupled by conductive paths 1606. Illustrative wafer translator 1602 further includes an evacuation pathway 1610, and a groove 1612 for receiving a gasket, such as an O-ring. The combination of evacuation pathway 1612 and a gasket (not shown) set in groove 1612, facilitate the removable attachment of a wafer with wafer translator 1602. Removable attachment may be achieved by aligning the wafer and wafer translator, bringing them into contact, and evacuating the space between them through evacuation path 1610.

It will be appreciated that removable attachment of the wafer with the wafer translator may be achieved with alternative arrangements, including but not limited to, aligning the wafer and wafer translator/gasket with each other, in an evacuated chamber, urging them into contact, and returning the atmosphere to the chamber. In this way, the space between the wafer and the wafer translator is evacuated without the need for an evacuation pathway through the translator.

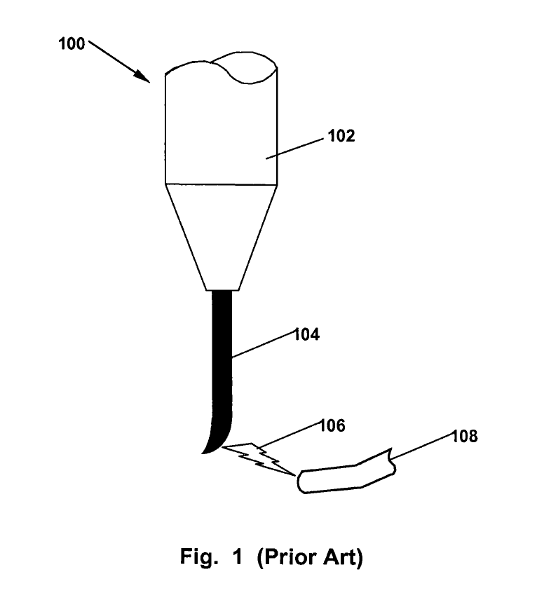

FIGS. 1-5 illustrate the formation of a contact structure suitable for use on a wafer translator. These contacts, which may be referred to as “tall bump contacts”, are formed with the use of multiple electronic flame-off operations to produce a free-air ball and at least one annealed zone.

Referring to FIG. 1, illustrates the operational relationship 100 in a wire-bonding machine that includes a capillary 102, a wire 104, an electronic flame-off (EFO) apparatus 108, during the conventional formation of a ball by means of the spark 106 generated by EFO 106. EFO apparatus 108 may also be referred to an EFO wand.

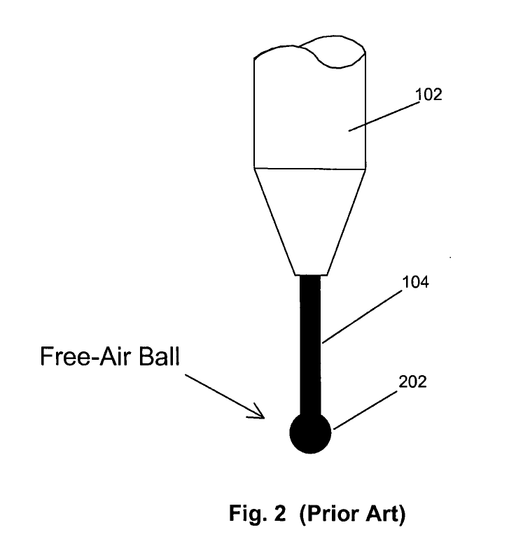

FIG. 2 shows a free-air ball 202 formed by the interaction of EFO apparatus 108 and wire 104.

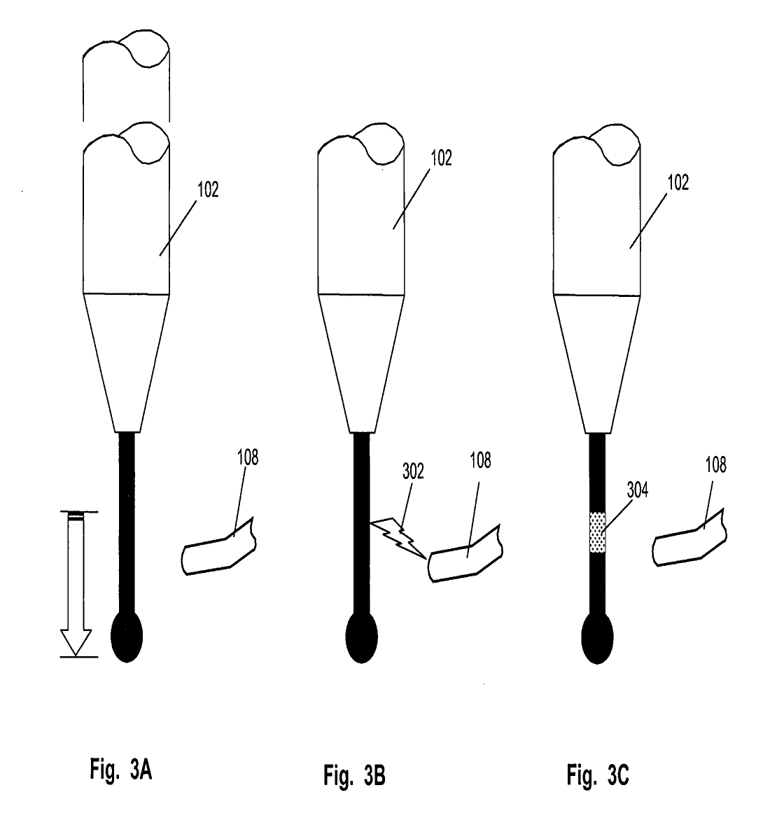

FIG. 3A shows capillary 102 moving relative to EFO apparatus 108. In other words, the capillary descends to a predetermined height. FIG. 3B illustrates an EFO operation 302 on a portion of the wire between the ball and the capillary. FIG. 3C shows an annealed zone 304 formed in the region of EFO operation 302. Annealed zone 304 may also be referred to as a heat-affected zone. Annealed zone 304, formed along flame-off areas as a consequence of EFO operation 302, has grain structures different from the rest of the wire. More particularly, annealed zone 304 has larger and weaker grains than the rest of the wire.

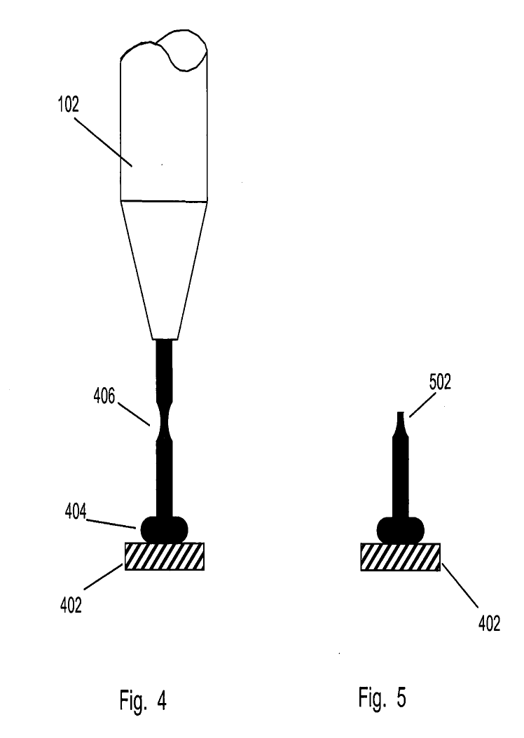

FIG. 4 is an illustration of the formation of a contact structure through the action of a wire bonding machine subsequent to forming an annealed zone in the wire and ball bonding the free-air ball to a contact pad. A conductive region 402 is the target for ball-bonding. In this illustrative embodiment, conductive region 402 is disposed on the wafer-side of a wafer translator (not shown). The ball-end of the wire is ball-bonded to conductive region 402 to form ball bond 404. Tail termination takes place at the annealed zone of weakened grain structures 406.

FIG. 5 is an illustration of the contact structure formed in accordance with a process of the present invention. A contact tip 502 is formed in the region of the annealed zone. The contact height and tip shape are determined, at least in part, by the EFO operations that modified the grain structure of the wire.

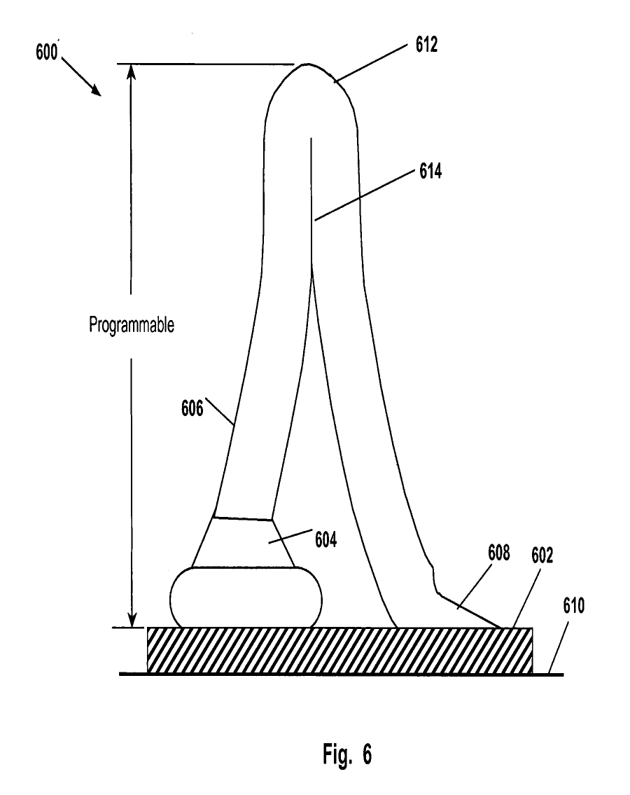

Referring to FIG. 6, an alternative contact structure 600 and method of fabrication are disclosed. FIG. 6 is a cross-sectional view of a folded contact structure 600 in accordance with the present invention in which a ball-bond 604 and a wedge-bond 608 are used. In this illustrative embodiment, both ball-bond 604 and wedge-bond 608 are disposed on conductive region 602. Conductive region 602 is disposed on the wafer-side 602 of a wafer translator. Ball-bond 604 and wedge-bond 608 are connected by a portion of wire 606. Wire 606 reaches a height above conductive region 602 that is determined by the programming of the wire-bonding machine. The uppermost portion of the loop of wire can be seen at 612. It is noted that wire 606 is folded into itself at 614 as shown in FIG. 6.

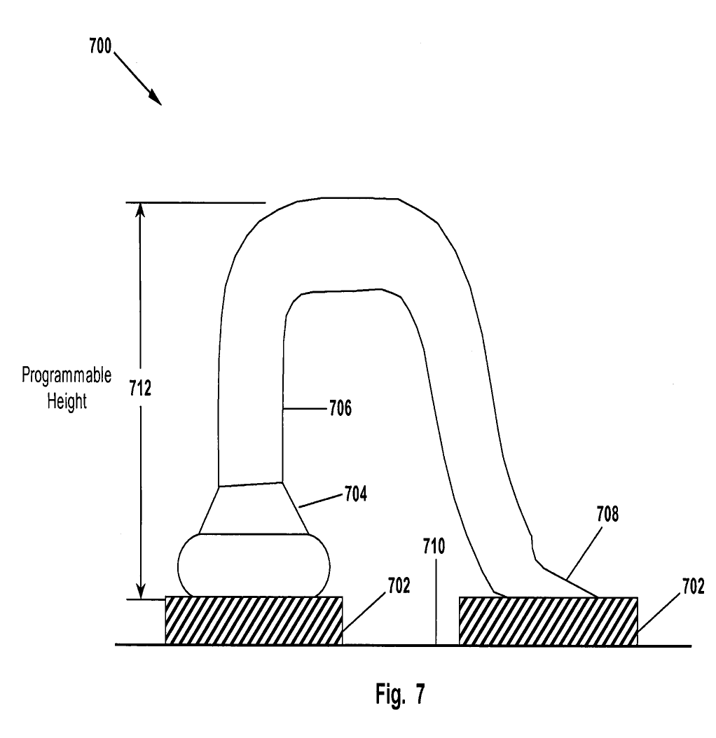

Referring to FIGS. 7-15, alternative contact structures and methods in accordance with the present invention are disclosed. FIG. 7 shows an intermediate stage of construction 700 of a pair of contact structures. A ball-bond 704 at a first end of wire loop 706, and a wedge-bond 708 at a second end of wire 706. Ball-bond 704 is disposed on a first contact pad of conductive material 702. Wedge-bond 708 is disposed on a second contact pad of conductive material 702. In this illustrative embodiment, conductive material 702 is disposed on the wafer-side 710 of a wafer translator. Wire 706 has a generally horizontal portion, the horizontal portion having a height 712 as measured from the top surface of conductive material 702. This height is programmable in that the wire-bonding machine, responsive to inputs it receives, controls the height of the horizontal portion.

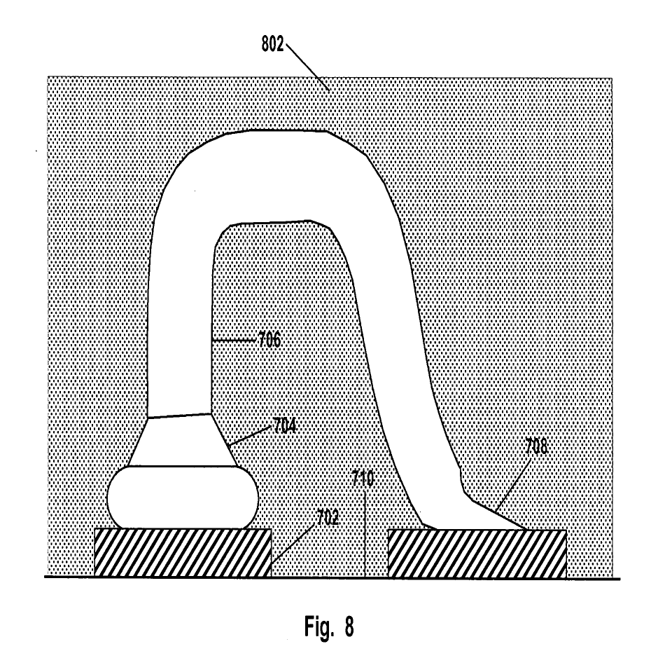

FIG. 8 shows the structure of FIG. 7, after a coating 802 of protective material is disposed over the wire loop.

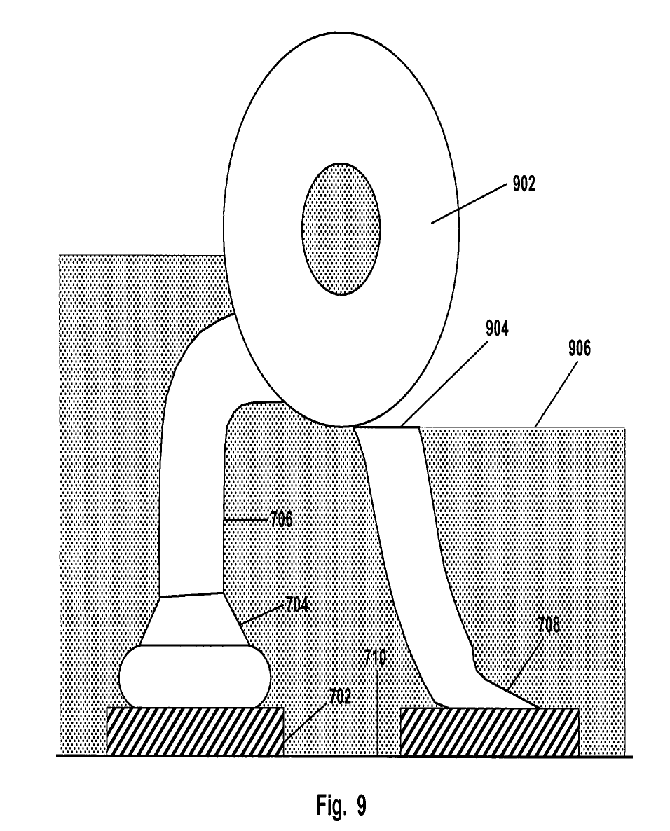

FIG. 9 shows the structure of FIG. 8, after a grinding wheel 902 has begun to remove an upper portion of the protective coating and the horizontal portion of wire 706. As can be seen in FIG. 9, the action of grinding wheel 902 produces a new upper surface 906 of the protective coating, and a new upper surface 904 of the wedge-bond side of the wire. It will be appreciated that by grinding away, or otherwise removing, the horizontal portion of wire 706, two discontiguous wire segments are created.

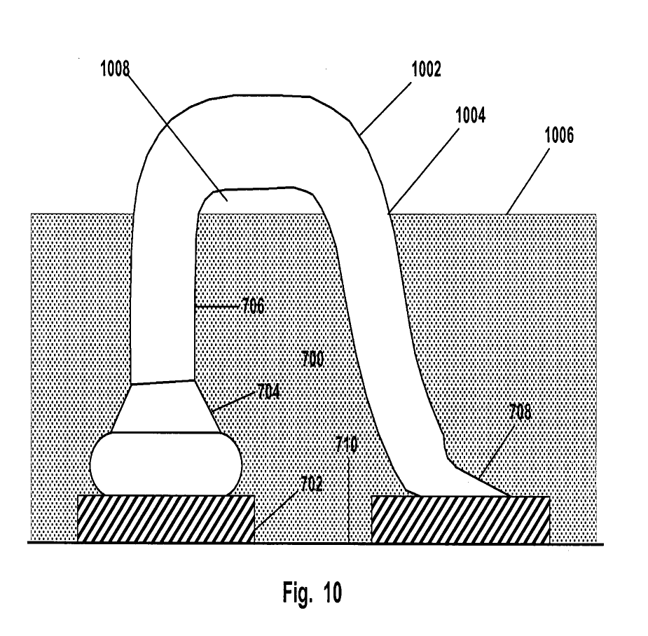

FIG. 10 shows the structure of FIG. 8, after an upper portion of the protective coating has been removed. Removing the upper surface of the protective coating by chemical etching creates a new surface 1006 for the protective coating. A newly exposed horizontal portion 1002 of wire 706 can be seen in the figure. It is noted that in this illustrative embodiment, a region 1008 under the horizontal portion 1002 is free from the protective coating material.

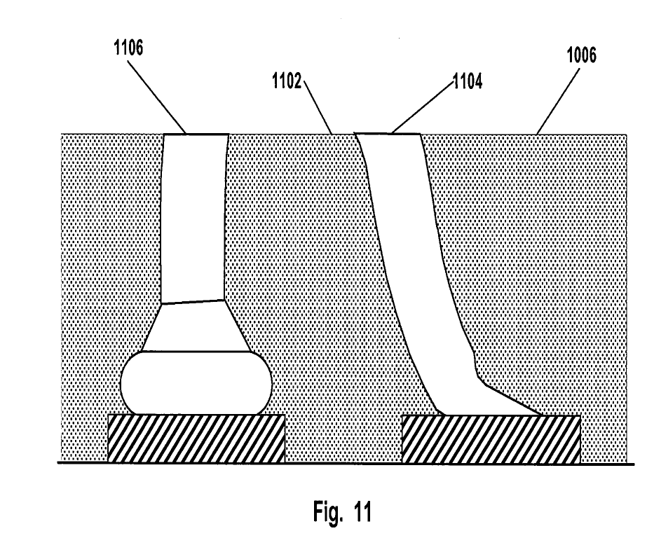

FIG. 11 shows the structure of FIG. 10, after the exposed horizontal portion of the wire has been removed. The exposed horizontal portion of the wire may be removed by any suitable means including but not limited to mechanical grinding, chemical etching, and chemical-mechanical polishing. After removal of the horizontal portion of the wire, there are two discontiguous portions of wire, the portion on the ball-bond side has an upper surface 1106 and the portion on the wedge-bond side has an upper surface 1104. The protective coating that was under the horizontal portion of the wire is shown at 1102.

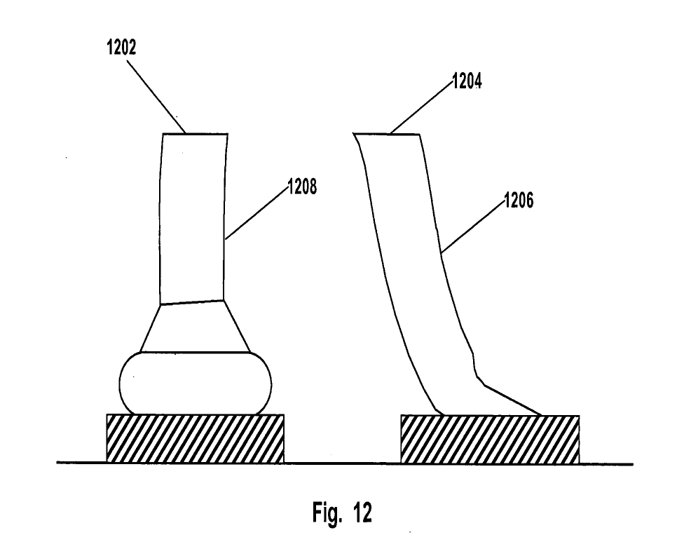

FIG. 12 shows the structure of FIG. 11, after the remainder of the protective coating is removed. Two contact structures now exist where there was previously a single loop of wire. The contact structure on the ball-bond side has an upwardly extending portion 1208 and a contact surface 1202. The contact structure on the wedge-bond side has an upwardly extending portion 1206 and a contact surface 1204. It is noted that these contact structures may be further shaped by a coining operation. It will be appreciated by those skilled in the art and having the benefit of the present disclosure that a variety of contact structure shapes and dimensions may be obtained by means of coining. Coining can be used for the initial formation of these contact structures as well as for refurbishing the contact structures.

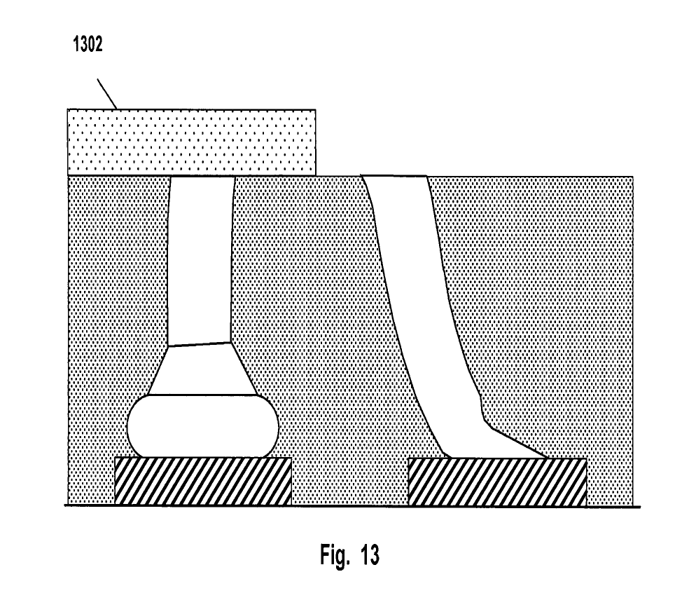

FIG. 13 shows the structure of FIG. 11, after a masking material 1302 is patterned onto the exposed surface of the remainder of the protective coating.

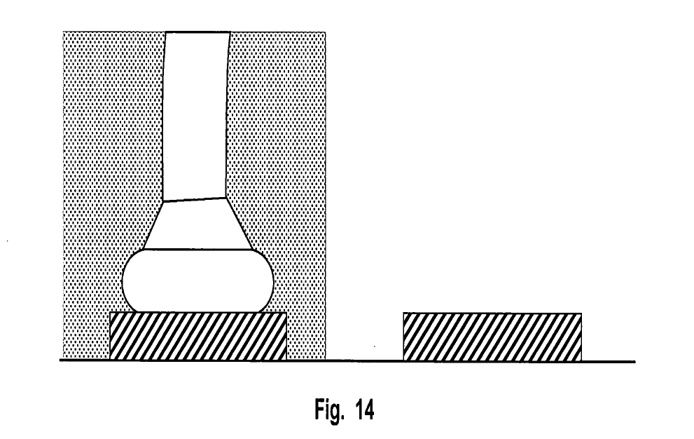

FIG. 14 shows the structure of FIG. 13, after the unmasked portion of the protective coating, and the wedge-bonded portion of the wire have been removed; and after the patterned masking material 1302 has been removed.

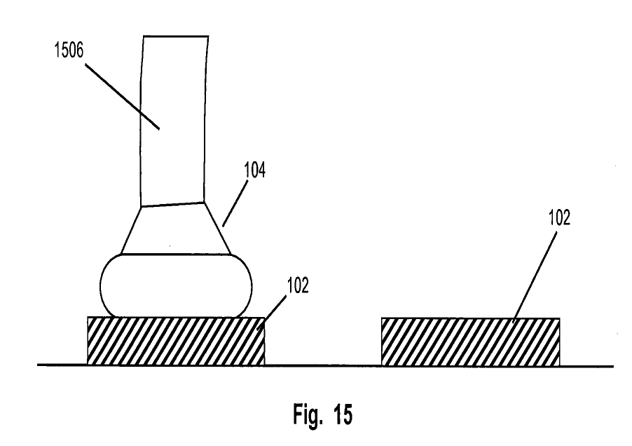

FIG. 15 shows the structure of FIG. 14, after the protective coating surrounding the ball-bonded portion of the wire has been removed, leaving a single contact structure 1506.

It is noted that the present invention is not limited to the use of any particular metal or metal alloy as the composition of the wire used to form the contact structures disclosed herein.

### CONCLUSION

Various embodiments of the present invention provide contact structures suitable for use with at least wafer translators.

Various embodiments of the present invention may find application in the fabrication of electrical contact structures.

It is to be understood that the present invention is not limited to the embodiments described above, but encompasses any and all embodiments within the scope of the subjoined Claims and their equivalents.

1. A method for forming a contact structure, comprising:
wirebonding a bond wire to a bond pad; and
removing a first portion of the bond wire spaced apart from the bond pad, leaving a second portion of the bond wire attached to the bond pad and having an exposed end spaced apart from the bond pad.
